(19) United States
(12) Patent Application Publication
(10) Pub. No.: US 2015/0346088 A1
(43) Pub. Date: Dec. 3, 2015

(54) METHOD AND APPARATUS FOR JUDGING POLISHING PERFORMANCE OF POLISHING LIQUID

(71) Applicant: EBARA CORPORATION, Tokyo (JP)

(72) Inventors: Chikako TAKATOH, Tokyo (JP); Yumiko NAKAMURA, Tokyo (JP); Tadashi OBO, Tokyo (JP); Hisanori MATSUO, Tokyo (JP)

(21) Appl. No.: 14/725,322

(22) Filed: May 29, 2015

(30) Foreign Application Priority Data
Jun. 2, 2014 (JP) 2014-113915

(51) Int. Cl. G01N 21/33; G01N 27/26; B24B 49/12; G01N 30/74; B24B 37/005

(52) U.S. Cl. CPC G01N 21/33; G01N 30/74; B24B 37/0056; B24B 49/12; G01N 27/26; G01N 2201/061

(57) ABSTRACT

A method for judging polishing performance of a polishing liquid, which can judge freshness of a slurry by measuring a component concentration or a physical quantity corresponding to the component concentration of the slurry after polishing and by evaluating an accelerator component and an inhibitor component of the slurry is disclosed. The polishing performance judging method of a polishing liquid judges polishing performance of a polishing liquid containing an accelerator for promoting dissolution of an object to be polished and an inhibitor for inhibiting dissolution of the object to be polished. The method includes analyzing a polishing waste liquid by spectroscopy, selecting a plurality of wavelengths from wavelengths which can distinguish the accelerator, the inhibitor, and a complex compound of the accelerator and a metal to be polished, and measuring absorbance at the selected plurality of wavelengths to thereby judge the polishing performance of the polishing liquid.

### CROSS REFERENCE TO RELATED APPLICATION

This document claims priority to Japanese Patent Application Number 2014-113915 filed Jun. 2, 2014, the entire contents of which are hereby incorporated by reference.

### BACKGROUND

In a planarization process of glass, liquid crystal panels, wafers, or the like, chemical mechanical polishing (CMP) technique is widely used. CMP is a method for performing mechanical polishing while supplying a polishing liquid (hereinafter, also referred to as slurry) containing abrasive particles and a chemical such as a complexing agent to an object to be polished, so that the surface roughness of the object to be polished can be controlled in the order of nm or less.

There are various types of slurries which are used in CMP depending on objects to be polished, and such slurries differ in respective components and liquid properties. Any type of slurry has freshness (i.e., the level of a polishing capability held by the polishing liquid) that is degraded as a polishing process progresses because polishing debris are accumulated in the slurry or components effective for polishing are consumed. Compared to the polishing capability of the slurry before it is used for polishing, the polishing capability of the slurry which has been used for polishing is generally degraded, and the level of the polishing capability is defined as “freshness”. In this manner, since the freshness of the slurry is degraded as the polishing process progresses, it is necessary to continue supplying of a fresh slurry at all times in order to obtain stable polishing performance. The surface condition of the object to be polished varies in an initial stage and in a final stage of the polishing process, and thus a decline rate of the freshness of the slurry is considered to differ in the initial stage and in the final stage accordingly. However, because it has been difficult to judge the freshness of the slurry after the polishing, a fresh slurry has been supplied at all times in an excess amount to supplement the freshness of the slurry. Thus, the stable polishing performance can be achieved. However, the slurry has been wastefully consumed in large amounts, and thus it has been problematic to increase the cost and to impose a heavy load on the environment.

The present inventors have attempted to solve the conventional problem that because it has been difficult to judge the freshness of the slurry after the polishing, a fresh slurry has been supplied at all times in an excess amount, and have examined the following matters.

Since there are various types of slurries, and such slurries differ in respective components and concentrations, there may be various possible causes of a change of the liquid properties. With regard to a change of absorbance, respective components such as metal ions, a complexing agent, and a metal complex are considered to have respective characteristic absorption wavelengths or respective characteristic absorption coefficients. Thus, if the metal ion concentration is changed or the metal complex concentration is changed with the progress of polishing, the absorption wavelength or the absorption coefficient of the entire liquid solution may be changed as well.

Studies on the relationship between the polishing liquid component and the polishing performance reveals that the polishing liquid component includes a complexing agent which inhibits dissolution of the object to be polished (hereinafter, referred to as inhibitor) and a complexing agent which promotes dissolution of the object to be polished (hereinafter, referred to as accelerator), and the competition among a plurality of complexing agents having such conflicting actions on a surface of a metal material to be polished produces a complex of the inhibitor and the metal to be polished and a complex of the accelerator and the metal to be polished at a certain concentration ratio, so that flat and smooth surface polishing is achieved. Therefore, key factors to maintain the freshness of the slurry are the concentration of the accelerator and the concentration of the inhibitor.

FIG. 11 is a schematic view showing a polishing cycle comprising three steps in the CMP process. In FIG. 11, a black square represents an accelerator, a white square represents an inhibitor, a black triangle represents an abrasive particle and other components, and a white circle represents a metal ion. As shown in FIG. 11, the accelerator forms a complex with a metal to be polished and an oxide surface of the metal to be polished and the formed complex is dissolved to allow the surface of the metal to be polished to be dissolved, and thus the metal surface of the convex portions are exposed (first step). At the same time, the inhibitor forms an insoluble complex layer with the metal to be polished, so that the insoluble complex layer protects the surface of the metal to be polished (second step). By polishing with a flat pad, only the convex portions of the insoluble complex layer formed on the surface of the metal to be polished are removed, and thus a metal surface is exposed after the removal (third step). The exposed metal surface is subjected immediately to the action of the accelerator and the inhibitor in the slurry to allow the surface of the metal to be polished to be dissolved by the accelerator and to form a complex layer by the inhibitor, and only the convex portions of the formed complex layer are polished again.

In the CMP process, flat surface polishing at the level of molecule can be achieved by repeating the chemical reaction and the polishing action at the surface of the metal to be polished. Therefore, the polishing performance can be maintained by keeping the respective concentrations of the accelerator and the inhibitor or the concentration ratio of the accelerator to the inhibitor in certain ranges. Further, the freshness of the slurry which can maintain the flat polishing performance at the level of molecule can be judged by detecting the concentrations of the accelerator and the inhibitor directly, or indirectly through the liquid property change.

As an example of the method for monitoring components of the slurry, there is a method for analyzing component concentrations by an electrothermal slurry atomic absorption spectrometer (Japanese laid-open patent publication No. 2003-188133). However, this method is intended to judge whether the slurry to be supplied is appropriate, but not to judge the freshness of the slurry after polishing or to control the supply amount of the slurry during polishing.

On the other hand, in the case where the slurry is used in a circulating manner, there is a method in which a zeta potential is monitored to detect the liquid property change of the slurry, and when the zeta potential becomes a predetermined value or less, the zeta potential is adjusted and the slurry is used in a circulating manner (Japanese laid-open patent publication No. 2011-167769). However, this method is intended to adjust the slurry to be supplied in an appropriate range, but not to control the supply amount of the slurry. Furthermore, since there are various types of slurries, and such slurries differ in active components, many types of slurries need different indexes to judge the freshness other than the zeta potential, and thus there are only limited types of slurries whose freshness can be judged by this method.

### SUMMARY OF THE INVENTION

According to embodiments, there is provided a method and an apparatus, for judging polishing performance of a polishing liquid, which can judge freshness of a slurry by measuring a component concentration or a physical quantity corresponding to the component concentration of the slurry after polishing and by evaluating an accelerator component and an inhibitor component of the slurry.

Embodiments, which will be described below, relate to a method and an apparatus, for judging polishing performance of a polishing liquid, which judges the polishing performance held by the polishing liquid.

In an embodiment, there is provided a method for judging polishing performance of a polishing liquid containing an accelerator for promoting dissolution of an object to be polished and an inhibitor for inhibiting dissolution of the object to be polished, the method comprising: analyzing a polishing waste liquid by spectroscopy; selecting a plurality of wavelengths from wavelengths which can distinguish the accelerator, the inhibitor, and a complex compound of the accelerator and a metal to be polished, respectively; and measuring absorbance at the selected plurality of wavelengths to thereby judge the polishing performance of the polishing liquid.

According to the above-described embodiment, the concentrations of the accelerator and the inhibitor contained in the polishing liquid can be determined by using inherent absorption wavelengths of the respective components or the complex compound with the metal to be polished.

In an embodiment, the wavelengths at which the absorbance is measured comprise a plurality of wavelengths selected from a range of 200 to 900 nm.

In an embodiment, at least one wavelength is selected from a range of 200 to 255 nm or a range of 450 to 900 nm, and at least one more wavelength is selected from a range of 255 to 310 nm.

In an embodiment, at least one wavelength is selected from a range of 255 to 310 nm, and at least one more wavelength is selected from wavelengths of ions of the metal to be polished.

In an embodiment, the method further comprises measuring electrochemical properties or chromaticity of ions of the metal to be polished, instead of selecting the at least one more wavelength from the wavelengths of the ions of the metal to be polished, wherein the polishing performance of the polishing liquid is judged by the absorbance at the wavelength selected from the range of 255 to 310 nm of the polishing waste liquid, and one of the measured electrochemical properties and the measured chromaticity of the ions of the metal to be polished.

In an embodiment, there is provided a method for judging polishing performance of a polishing liquid comprising: measuring a component concentration of a polishing waste liquid to obtain a signal value based on the measured value; and processing the obtained signal value and a pre-obtained signal value to thereby judge the polishing performance of the polishing liquid.

In an embodiment, there is provided a method for judging polishing performance of a polishing liquid comprising: causing a polishing waste liquid to pass through a reaction unit having a reactant which reacts with the polishing waste liquid, thereby causing the polishing waste liquid to react with the reactant; measuring a component concentration of the polishing waste liquid after the reaction in the reaction unit to obtain a signal value based on the measured value; and processing the obtained signal value and a pre-obtained signal value to thereby judge the polishing performance of the polishing liquid.

According to the above-described embodiment, by providing the reaction unit having the reactant which reacts with the polishing waste liquid, the accelerator or the inhibitor contained in the polishing waste liquid is allowed to react with the reactant, and thus the component concentration after passing of the polishing waste liquid through the reaction unit can be measured easily.

In an embodiment, there is provided a method for judging polishing performance of a polishing liquid comprising: measuring a component concentration of a polishing waste liquid to obtain a signal value based on the measured value; causing the polishing waste liquid to pass through a reaction unit having a reactant which reacts with the polishing waste liquid, thereby causing the polishing waste liquid to react with the reactant; measuring a component concentration of the polishing waste liquid after the reaction in the reaction unit to obtain a signal value based on the measured value; and processing the signal value obtained from the polishing waste liquid before passing through the reaction unit and the signal value obtained from the polishing waste liquid after passing through the reaction unit, thereby judging the polishing performance of the polishing liquid.

In an embodiment, the polishing waste liquid passes through the reaction unit having a reaction passage constituted by a solid comprising a component of a metal to be polished which reacts with the component of the polishing waste liquid.

In an embodiment, the solid which constitutes the reaction passage comprises a metal, a metal salt, or a metal complex.

In an embodiment, a chemical agent which reacts with the component of the polishing waste liquid is added into the reaction unit.

In an embodiment, a chemical reactant to be added comprises an indicator, metal ions, or a metal complexing agent.

In an embodiment, a method for measuring the component concentration comprises an electrochemical method.

In an embodiment, a method for measuring the component concentration comprises spectroscopy.

In an embodiment, a wavelength to be measured comprises a wavelength selected from a range of 200 to 900 nm.

In an embodiment, wavelengths to be measured comprise a plurality of wavelengths selected from a range of 200 to 900 nm.

In an embodiment, components of the polishing waste liquid is separated by a component separating device, and each component concentration is measured after the separation.

In an embodiment, the separating device of the polishing waste liquid comprises chromatography.

In an embodiment, the component concentration is measured by detecting a physical concentration change.

In an embodiment, the component concentration is measured by an optical refractive index method or a light scattering method.

In an embodiment, there is provided an apparatus for judging polishing performance of a polishing liquid comprising: a detecting unit configured to detect a component of a polishing waste liquid extracted from a polishing apparatus to obtain a detection signal; and an analyzing unit configured to analyze the detection signal sent from the detecting unit to thereby judge the polishing performance of the polishing liquid.

In an embodiment, there is provided an apparatus for judging polishing performance of a polishing liquid comprising: a reaction unit having a reactant which reacts with a polishing waste liquid extracted from a polishing apparatus; a detecting unit configured to detect a component of the polishing waste liquid after passing through the reaction unit to obtain a detection signal; and an analyzing unit configured to analyze the detection signal sent from the detecting unit to thereby judge the polishing performance of the polishing liquid.

In an embodiment, there is provided an apparatus for judging polishing performance of a polishing liquid comprising: a first detecting unit configured to detect a component of a polishing waste liquid extracted from a polishing apparatus to obtain a detection signal; a reaction unit having a reactant which reacts with the polishing waste liquid discharged from the first detecting unit; a second detecting unit configured to detect a component of the polishing waste liquid after passing through the reaction unit to obtain a detection signal; and an analyzing unit configured to analyze the detection signal sent from the first detecting unit and the detection signal sent from the second detecting unit to thereby judge the polishing performance of the polishing liquid.

In an embodiment, the reactant is a solid, composed of a component of a metal to be polished, which comprises the metal to be polished, a salt of the metal to be polished, or a complex of the metal to be polished.

In an embodiment, the reactant comprises an indicator, metal ions, or a metal complexing agent.

In an embodiment, the component of the polishing waste liquid is detected by an electrochemical method.

In an embodiment, the component of the polishing waste liquid is detected by spectroscopy.

In an embodiment, a wavelength to be measured comprises a wavelength selected from a range of 200 to 900 nm.

In an embodiment, wavelengths to be measured comprise a plurality of wavelengths selected from a range of 200 to 900 nm.

In an embodiment, components of the polishing waste liquid are separated by a component separating device, and each component of the polishing waste liquid is detected after the separation.

In an embodiment, the separating device, of the polishing waste liquid comprises chromatography.

In an embodiment, the component of the polishing waste liquid is detected by detecting a physical concentration change, or by an optical refractive index method or a light scattering method.

In an embodiment, there is provided a polishing apparatus comprising: a polishing table configured to support a polishing pad; a holding device configured to hold an object to be polished; a polishing liquid supply device configured to supply a polishing liquid onto the polishing pad; a polishing waste liquid extraction mechanism configured to extract a polishing waste liquid discharged from the polishing pad; the above-described apparatus for judging polishing performance; and a polishing liquid control unit connected to the apparatus for judging the polishing performance; wherein the apparatus for judging polishing performance detects a component of the polishing waste liquid to obtain a detection signal, analyzes the detection signal to obtain a polishing performance judgment signal, and sends the polishing performance judgment signal to the polishing liquid control unit; and the polishing liquid control unit controls a flow rate of the polishing liquid to be supplied onto the polishing pad.

The above-described embodiments offer the following advantages.

(1) The freshness of the slurry can be judged by measuring a component concentration or a physical quantity corresponding to the component concentration of the slurry after polishing and by evaluating an accelerator component and an inhibitor component of the slurry.

(2) Based on the above-described judgment result of the slurry, the supply amount of the slurry to be supplied onto the polishing pad of the polishing apparatus can be controlled appropriately. Specifically, in the case where the judgment result shows high freshness of the slurry, the supply amount of the slurry can be controlled to be reduced, while in the case where the judgment result shows low freshness of the slurry, the supply amount of the slurry can be controlled to be increased.

(3) By controlling the supply amount of the slurry appropriately, the amount of the slurry to be used can be reduced while maintaining the freshness of the slurry appropriately, thus reducing the cost and the environmental load.

### BRIEF DESCRIPTION OF THE DRAWINGS

FIG. 1 is a view showing the evaluation according to absorbance characteristics based on spectroscopy;

FIG. 2 is a schematic perspective view showing an embodiment of a polishing apparatus which performs a method for judging polishing performance of a polishing liquid;

FIG. 3 is a block diagram showing an example of a control configuration in the polishing apparatus shown in FIG. 2;

FIG. 4 is a view showing another embodiment of a polishing apparatus which performs the method for judging polishing performance of the polishing liquid, and a schematic perspective view showing an embodiment equipped with a reaction unit in which the reaction with components contained in a slurry is conducted;

FIG. 5 is a block diagram showing an example of a control configuration in the polishing apparatus shown in FIG. 4;

FIG. 6 is a schematic perspective view showing still another embodiment of a polishing apparatus which performs the method for judging polishing performance of the polishing liquid;

FIG. 7 is a block diagram showing an example of a control configuration in the polishing apparatus shown in FIG. 6;

FIGS. 8A, 8B, 8C and 8D are schematic views each showing a configuration of the reaction unit;

FIGS. 9A, 9B and 9C are schematic views each showing a configuration of the reaction unit having a regeneration mechanism;

FIG. 10 is a block diagram showing an embodiment in which a component separating means is provided at an upstream side of a measurement unit of a component concentration of the polishing liquid or a polishing waste liquid to estimate the polishing performance of the polishing liquid; and

FIG. 11 is a schematic view showing a polishing cycle comprising three steps in a CMP process.

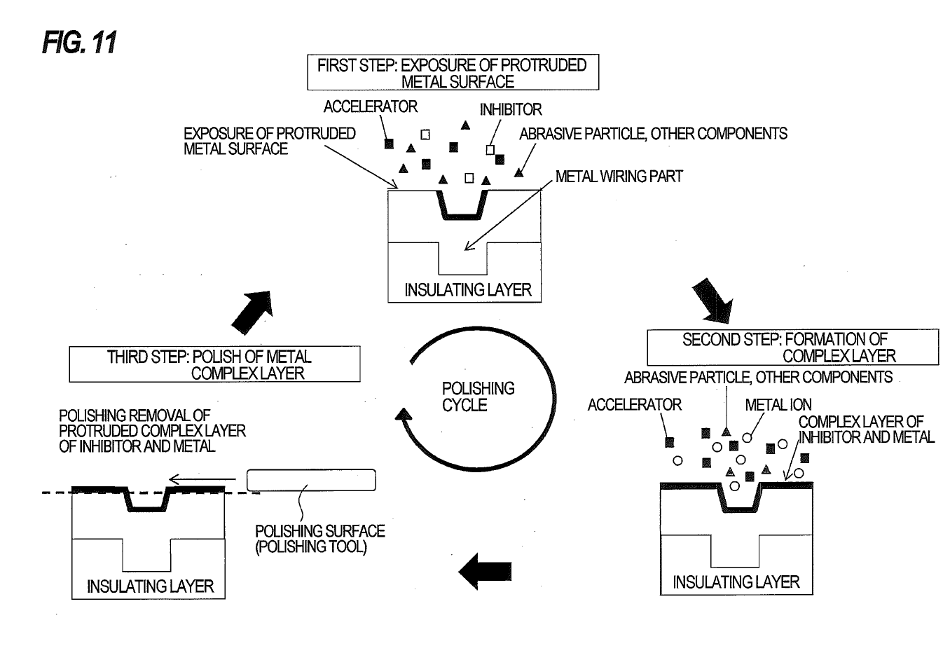

### DESCRIPTION OF EMBODIMENTS

Embodiments of a method for measuring a component concentration of a polishing liquid (slurry) will be described in detail below.

CMP slurries contain several kinds of components which form complexes with a metal to be polished or with an oxide thereof. These components react with the metal or the oxide thereof to produce complex compounds. Among such components, an accelerator which forms a soluble complex compound contributes to the enhancement of a polishing rate, and an inhibitor which forms an insoluble complex compound contributes to the formation of a planarized polished surface. Therefore, if the concentrations of the inhibitor and the accelerator fall within respective appropriate ranges and the concentration ratio of complexing agents having conflicting actions, i.e., the inhibitor and the accelerator, falls within a certain range, smoothness of the surface of the polished material can be achieved, and polishing at a high polishing rate can be achieved. Hereinafter, the smoothness and the high polishing rate, which are two types of performance of a polishing liquid (slurry), are collectively referred to as polishing performance of the polishing liquid (slurry).

Therefore, for controlling the slurry in order to maintain the polishing performance of the slurry, first of all, it is necessary to know respective concentrations of the accelerator and the inhibitor.

In an embodiment, the inhibitors and the accelerators contained in the polishing liquid are as follows:

The inhibitors include benzotriazole (1,2,3-benzotriazole, BTA), tolutriazole (4- or 5-Methyl-1H-benzotriazolemTolyltriazole, TTA), carboxybenzotriazole, 2-mercaptobenzothiazole (MBT), 2,5-dimercaptothiadiazole (DMTDA), benzimidazole (BIA), benzimidazolethiol (2-benzimidazolthiol or 2-mercaptobenzimidazole, BIT), 1,2,4-triazole, 1,2,3-triazole, quinaldic acid, quinolinic acid, kynurenic acid, picolinic acid, nicotinic acid, and the like.

The accelerators include amino acid, and the amino acid includes glycine, alanine, arginine, asparagine, aspartic acid, cysteine, glutamine, glutamic acid, glycine, isoleucine, leucine, lysine, methionine, phenylalanine, serine, threonine, tyrosine, valine, and the like. Among the above, glycine and alanine are effective as the accelerator.

Since a typical CMP slurry contains an excessive amount of the accelerator component, a shortage of the inhibitor component is considered to degrade the polishing performance. Thus, the method for detecting a low concentration of the inhibitor component from the slurry containing a high concentration of the accelerator component is required. Since a complex compound produced by reaction of the accelerator component and the metal to be polished is soluble in water, various detecting methods, including a method to detect the accelerator component or the complex component thereof, a method to detect ions of the metal to be polished, and other methods, can be employed. On the other hand, the inhibitor component has a low concentration and low detection sensitivity, and an insoluble complex component formed by the inhibitor and the metal to be polished is solid. Therefore, means for detecting the inhibitor component are limited.

In an embodiment, several methods to solve the above-described problems are proposed.

First, there are methods for controlling the polishing performance of the slurry by measuring a concentration of excessively existing accelerator component to estimate remaining amount of the inhibitor component.

The slurry is passed through a reaction unit having a reactant which reacts with the component contained in the slurry, and a component concentration of the compound of the accelerator and the metal to be polished is measured after the slurry passes through the reaction unit, so that the concentration of the inhibitor can be grasped by evaluating the correlation between the measured component concentration and pre-obtained data (e.g., data of the initial slurry before it is used). Alternatively, the change of reacted amount of the inhibitor can be grasped by measuring and comparing the component concentration of the compound of the accelerator and the metal to be polished at an upstream side and at an downstream side of the reaction unit, i.e., before and after passing of the slurry through the reaction unit.

Further, there are methods for determining respective concentrations of the accelerator and the inhibitor simultaneously by using inherent physical property values of the respective components. Specifically, there is a method for determining respective concentrations of the accelerator and the inhibitor simultaneously by using a characteristic absorption wavelength of the accelerator and a characteristic absorption wavelength of the inhibitor or a characteristic absorption wavelength of the complex of the metal to be polished. There are methods for determining the accelerator component by using physical properties of ions of the metal to be polished produced by the reaction with the accelerator, but not by directly detecting the accelerator or the complex formed from the accelerator and the metal to be polished. Specifically, there is a method for determining the accelerator component by electric conductivity.

Furthermore, there is a method in which a separating means is provided at an upstream side of a detecting unit to separate and then detect the accelerator component and the inhibitor component, respectively. In spectroscopy and mass spectrometry, a characteristic physical property value of each component is selected and detected, so that each component concentration can be measured. Also, in a measuring method for detecting the total amount of plural components, each component concentration can be measured if such method is combined with a component separating means such as chromatography and used as a detecting means after the separation.

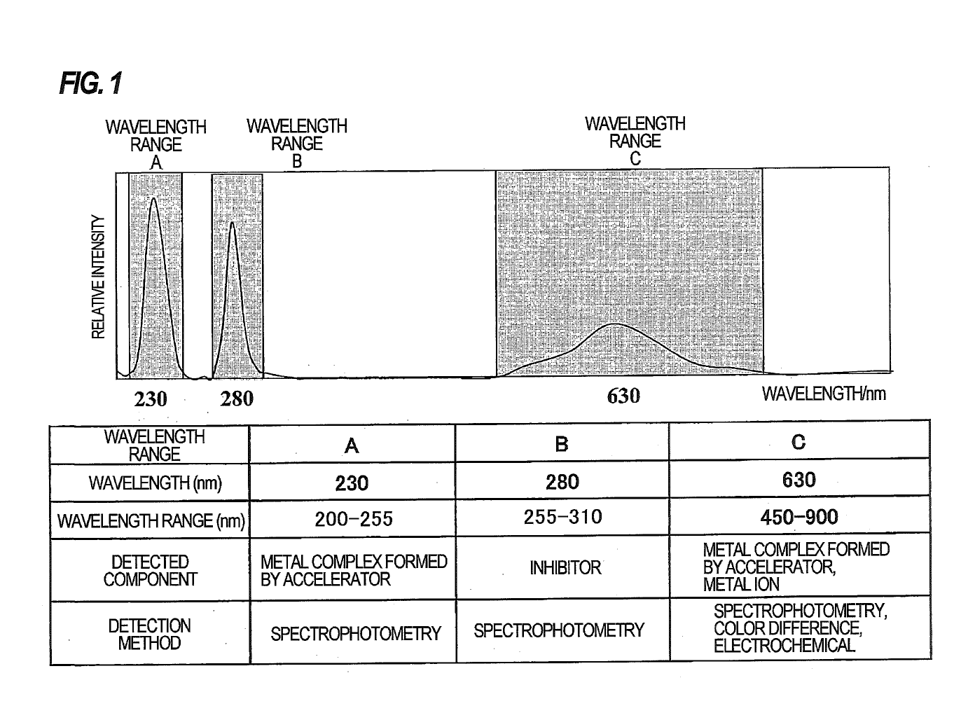

FIG. 1 is a view showing the evaluation according to the absorbance characteristics based on the above-mentioned spectroscopy. Three substances, i.e. a metal complex formed by an accelerator, an inhibitor, and a mixture of the metal complex formed by the accelerator and metal ions, which are contained in the slurry which has been used for polishing are detected.

A slurry which employs glycine as the accelerator and benzotriazole as the inhibitor is used, and a metal to be polished is Cu. Here, the metal complex formed by an accelerator refers to a complex compound formed by the accelerator and a metal to be polished.

The metal complex formed by an accelerator is detected at a wavelength range A to show a peak at the wavelength of 230 nm, the inhibitor is detected at a wavelength range B to show a peak at the wavelength of 280 nm, and the metal complex formed by an accelerator and metal ions are detected at a wavelength range C to show a peak at the wavelength of 630 nm. The wavelength range A ranges from 200 to 255 nm, the wavelength range B ranges from 255 to 310 nm, and the wavelength range C ranges from 450 to 900 nm. The wavelength ranges shown by spectrophotometry differ depending on types of the accelerator and the inhibitor which are used, and the metal to be polished, and show respective distinctive ranges.

The concentration of the accelerator can be analyzed from the spectrophotometry at the wavelength range A and the wavelength range C, and the concentration of the inhibitor can be analyzed from the spectrophotometry at the wavelength range B. In the case where the object to be detected has high solution characteristics, such as a mixture of the metal complex formed by the accelerator and the metal ions detected at the wavelength range C, the object can be detected by color difference or an electrochemical method such as electrical conductivity, other than the spectrophotometry.

In the case where it is judged that the concentrations of the inhibitor and the accelerator in the CMP slurry fall within respective appropriate ranges and the freshness of a complex slurry having conflicting actions is high, the supply amount of the slurry is reduced. In this case, methods for detecting whether the concentration ratio of the complexing agents, i.e., the inhibitor and the accelerator, falls within a certain range include the following 1 to 4 methods including the above-described spectroscopy.

1. Concentration Detecting Method by Means of Spectroscopy (Absorbance Method, Fluorescence, Emission, Etc.) for Detecting a Plurality of Component Concentrations at a Plurality of Wavelengths (See FIG. 1)

The concentration of the accelerator is analyzed from the spectrophotometry at the wavelength range A or the wavelength range C, and the concentration of the inhibitor is analyzed from the spectrophotometry at the wavelength range B.

2. Method for Detecting a Plurality of Component Concentrations by Using a Wavelength Related to the Accelerator (See FIG. 1)

(1) The accelerator concentration and the inhibitor concentration are analyzed by using the spectrophotometry at the wavelength range A or the wavelength range C and comparison with the database of the CMP slurry before being used for polishing.

(2) The accelerator concentration and the inhibitor concentration are analyzed from the change of the spectrophotometry at the wavelength range A or at the wavelength range C before and after passing of the slurry through the reaction unit.

3. Method for Detecting the Component Concentration by Detecting Concentrations of Non-Metal Ion Components (without Dispersion) by Means of Color Difference or Electrical Conductivity
(1) The accelerator concentration and the inhibitor concentration are analyzed by the comparison with the database.

(2) The accelerator concentration and the inhibitor concentration are analyzed from the change of the color difference or the electrical conductivity before and after passing of the slurry through the reaction unit.

4. Method for Detecting Each Component Concentration after Separation of the Components of the CMP Slurry (without Dispersion)

Absolute values of the respective component concentrations are detected after separation of components of the accelerator and the inhibitor by a separating means (chromatography or the like). It is sufficient for concentration detecting methods to detect concentrations without depending on components. Therefore, the concentration detecting methods include spectroscopy, an absorbance method, a refractive index method, an electrochemical method, a light scattering method, and the like.

In order to measure the concentrations of the components contained in the CMP slurry, each component concentration needs to be detected as some kind of physical quantity. General methods for detecting a substance concentration of a component in a solution include an optical method, an electrochemical method, and a mass method. The optical method includes an absorbance method (ultraviolet, visible, infrared, and near-infrared), polarimetry, circular dichroism spectroscopy, fluorescence spectroscopy, a refractive index method, an evaporative light scattering method, chemiluminescence spectroscopy, bioluminescence spectroscopy, an atomic absorption method, a light scattering method, a raman scattering method, a color difference method, an x-ray fluorescence method, an x-ray diffraction method, and the like. The optical method may measure concentrations by using a dispersed light, or may measure concentrations by a particularly limited wavelength (wavelengths). By measuring with a dispersed light or measuring with a plurality of wavelengths, each of the concentrations of respective components can be measured. Next, the electrochemical method includes electrochemical, electrical conductivity, dielectric constant, ion electrode, hydrogen ion exponent, oxidation-reduction potential, and the like. Further, the mass method includes inductively coupled plasma-mass spectrometry, electrospray mass spectrometry, and atmospheric pressure chemical ionization mass spectrometry. The mass spectrometry may detect a component concentration in a particular range of mass, or may measure the component concentration by the measurement at a particular mass or in a particularly limited range of mass. Furthermore, in addition to the above methods, a concentration in a solution may be measured by using radiation, corona charged particle, hydrogen flame ionization, heat, viscosity, ultrasonic wave, or the like.

In order to measure each of the concentrations of respective components in the slurry without using a special separating means, it is preferable to use an ultraviolet/visible (UV/Vis) absorptiometric method, inductively coupled plasma-atomic emission spectroscopy (ICP-AES(OES)), inductively coupled plasma-mass spectrometry (ICP-MS), or liquid chromatography-mass spectrometry (LC-MS) among the above detecting methods.

On the other hand, it is possible to use some kind of separating means, such as liquid chromatography (HPLC), ion chromatography (IC), and capillary electrophoresis (CE), at an upstream side of a detector provided in the detecting unit. In such case, since the component can be distinguished by the difference in holding time (the time from the injection into the separating device until the detection by the detector) of each component, the concentration of each component can be measured even if the detector, using differential refractive index (RI), light scattering, electrical conductivity (CD), or the like, which cannot distinguish each component by itself is employed. Further, if the objective components are separated and introduced into the detector, the measurement sensitivity and the accuracy are expected to be improved in many cases.

The combination of the separating device and the detector can be any combination selected from the above methods, and especially, high performance liquid chromatography-ultraviolet/visible absorptiometric method (HPLC-UV/Vis), high performance liquid chromatography-mass spectrometry (HPLC-MS), ion chromatography-electrical conductivity (IC-CD), ion chromatography-mass spectrometry (IC-MS), and high performance liquid chromatography-inductively coupled plasma-mass spectrometry (HPLC-ICP-MS) may be effective.

Generally, when the separating means is installed at an upstream side of the detector, it becomes difficult to measure the component concentration in the slurry in real time. For example, the separation by high performance liquid chromatography (HPLC) is estimated to need at least approximately five minutes. However, by using ultra-high performance liquid chromatography (UPLC) instead of the high performance liquid chromatography (HPLC), the time required for separation can be shortened to approximately one minute at minimum.

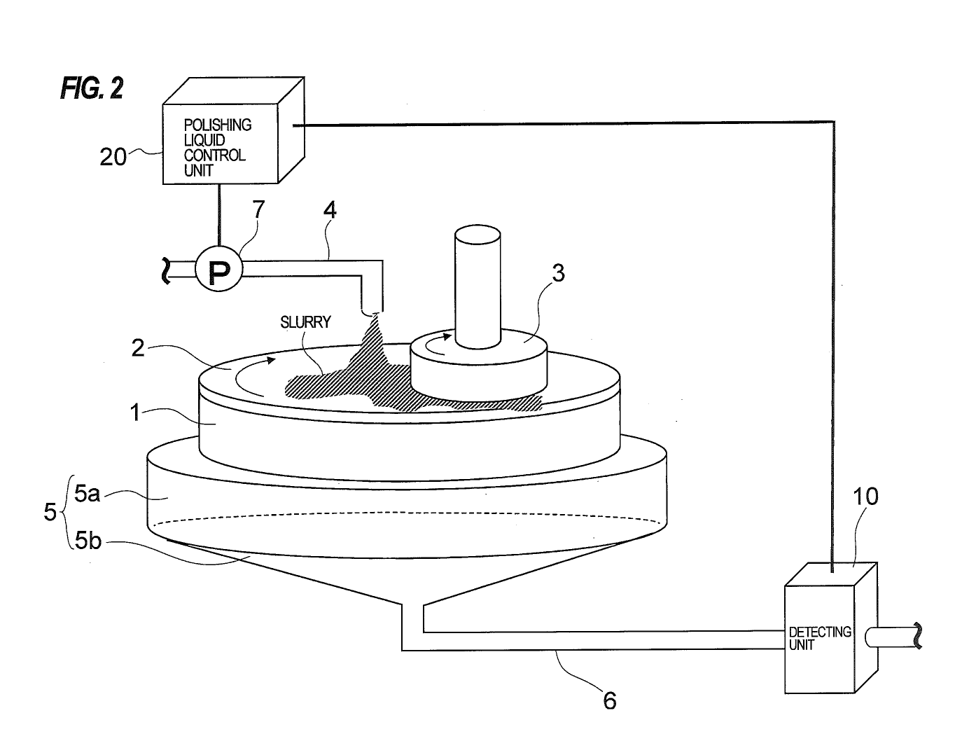

Embodiments of method for judging polishing performance of a polishing liquid will be described below with reference to FIGS. 2 through 10. Like or corresponding structural elements are denoted by like or corresponding reference numerals in FIGS. 2 through 10 and will not be described below in duplication.

FIG. 2 is a schematic perspective view showing an embodiment of a polishing apparatus which performs the method for judging polishing performance of the polishing liquid. As shown in FIG. 2, the polishing apparatus comprises a polishing table 1 for supporting a polishing pad 2, a polishing head 3 for holding a substrate such as a semiconductor wafer as an object to be polished and pressing the substrate against the polishing pad 2 on the polishing table 1, and a polishing liquid supply nozzle 4 for supplying the polishing liquid (slurry) onto the polishing pad 2.

The polishing head 3 is configured to hold the substrate such as a semiconductor wafer on its lower surface under vacuum attraction. The polishing head 3 and the polishing table 1 are rotated in the same direction as shown by arrows, and in this state, the polishing head 3 presses the substrate against the polishing pad 2. The polishing liquid (slurry) is supplied from the polishing liquid supply nozzle 4 onto the polishing pad 2, and the substrate is brought in sliding contact with the polishing pad 2 in the presence of the polishing liquid and is polished.

Immediately below the polishing table 1, there is provided a polishing waste liquid extraction mechanism 5 which comprises a cylindrical part 5a having an outside diameter slightly larger than that of the polishing table 1 and arranged so as to surround the lower peripheral portion of the polishing table 1, and a funnel part 5b coupled to the lower end of the cylindrical part 5a. The polishing waste liquid extraction mechanism 5 is configured to extract (or collect) a polishing waste liquid discharged from the polishing pad 2. The polishing waste liquid extraction mechanism 5 may be constituted by a suction pump for sucking and extracting the polishing liquid immediately after it is used for polishing of the substrate on the polishing pad 2. The polishing waste liquid extracted (or collected) by the polishing waste liquid extraction mechanism 5 is delivered to a detecting unit 10 through a waste liquid pipe 6. The detecting unit 10 is connected to a polishing liquid control unit 20. The polishing liquid supply nozzle 4 is equipped with a polishing liquid supply pump 7, which is connected to the polishing liquid control unit 20. The polishing liquid control unit 20 controls a flow rate of the polishing liquid (slurry) to be supplied onto the polishing pad 2 by controlling the polishing liquid supply pump 7.

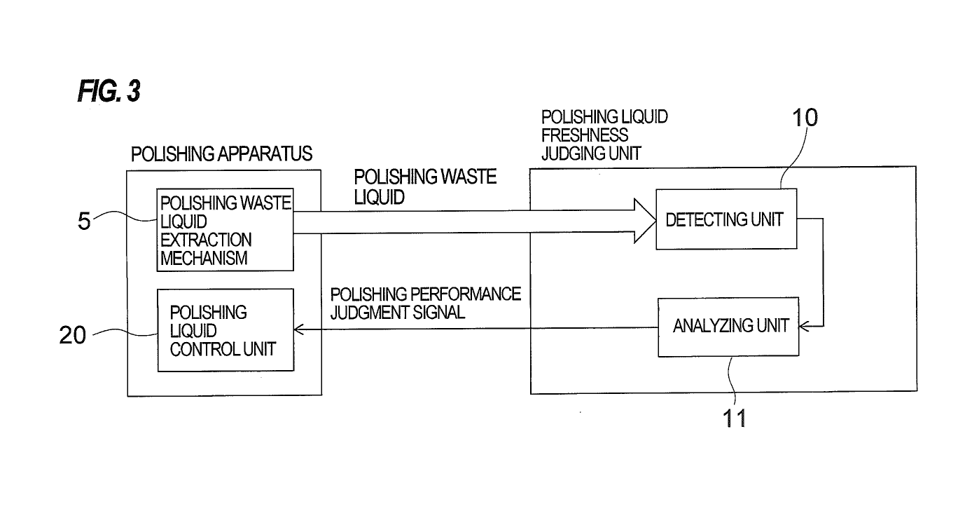

FIG. 3 is a block diagram showing an example of a control configuration in the polishing apparatus shown in FIG. 2. As shown in FIG. 3, the polishing waste liquid is delivered to the detecting unit 10 from the polishing waste liquid extraction mechanism 5 of the polishing apparatus. A predetermined component of the polishing waste liquid is detected in the detecting unit 10, and the detection signal is sent to an analyzing unit 11. In the analyzing unit 11, the detection signal is compared with a pre-stored appropriate range signal to judge the polishing performance of the polishing liquid. The detecting unit 10 and the analyzing unit 11 constitute a polishing liquid freshness judging unit. The analyzing unit 11 sends a polishing performance judgment signal of the polishing liquid to the polishing liquid control unit 20. The polishing liquid control unit 20 controls the polishing liquid supply pump 7 (see FIG. 2) on the basis of the polishing performance judgment signal to thereby control the flow rate of the polishing liquid (slurry) to be supplied onto the polishing pad 2.

In one embodiment, the detecting unit 10 shown in FIGS. 2 and 3 detects whether the concentration of the inhibitor, the concentration of the accelerator, and the concentration ratio of the inhibitor and the accelerator are within respective appropriate ranges, thereby keeping the condition of the polishing liquid within an appropriate range.

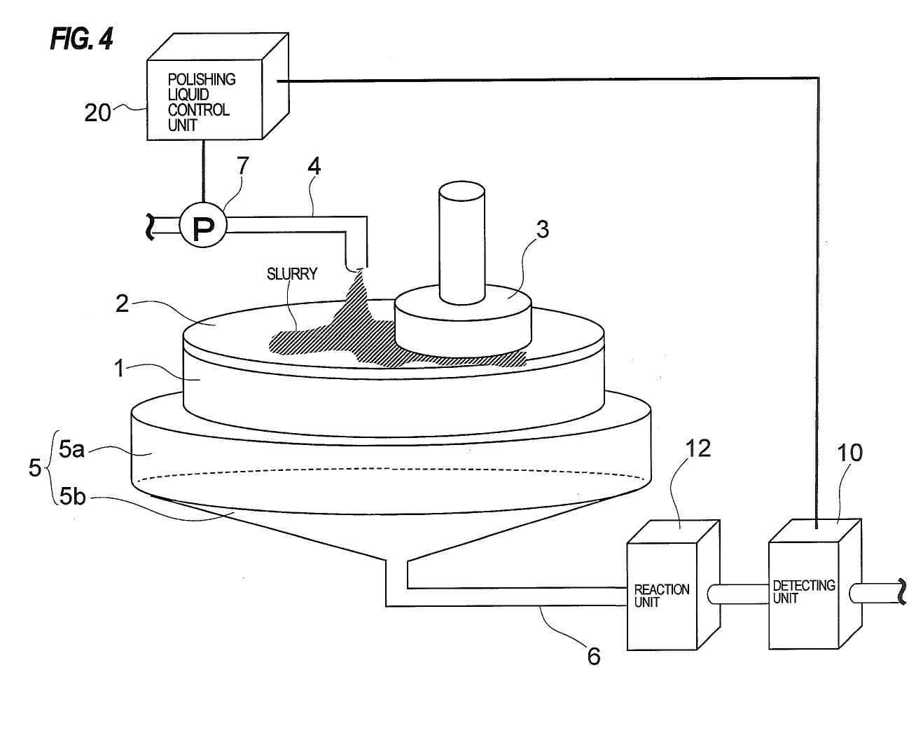

FIG. 4 is a view showing another embodiment of a polishing apparatus which performs the method for judging polishing performance of the polishing liquid, and a schematic perspective view showing an embodiment equipped with a reaction unit in which the reaction with the components contained in the slurry is conducted. In the embodiment shown in FIG. 4, a polishing waste liquid extracted (or collected) by a polishing waste liquid extraction mechanism 5 is delivered to a reaction unit 12 through a waste liquid pipe 6, and the polishing waste liquid after the reaction in the reaction unit 12 is delivered to a detecting unit 10. Other structure is the same as that of the polishing apparatus shown in FIG. 2.

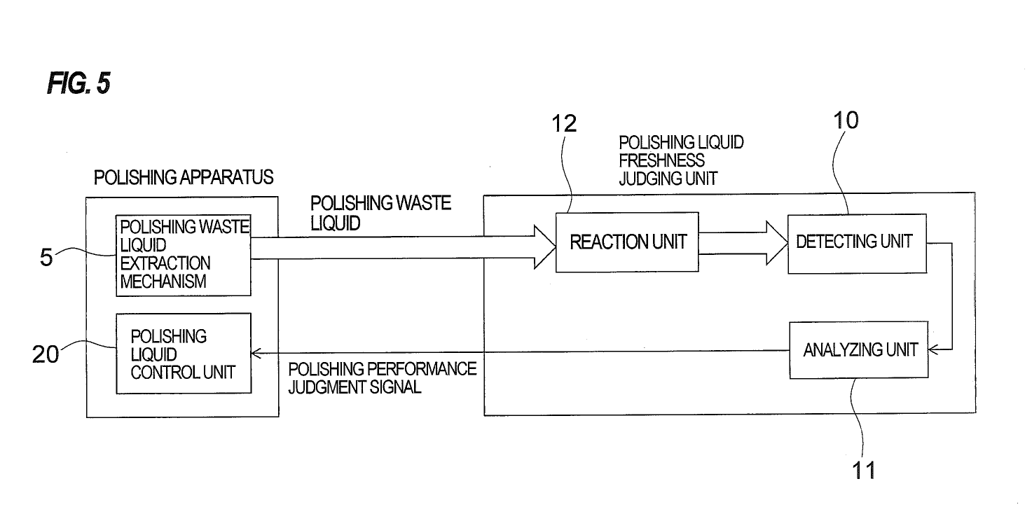

FIG. 5 is a block diagram showing an example of a control configuration in the polishing apparatus shown in FIG. 4. As shown in FIG. 5, the polishing waste liquid is delivered to the reaction unit 12 from the polishing waste liquid extraction mechanism 5 of the polishing apparatus. In the reaction unit 12, a predetermined reaction of the polishing waste liquid is performed, and the polishing waste liquid after the reaction is delivered to the detecting unit 10. A predetermined component of the polishing waste liquid is detected in the detecting unit 10, and the detection signal is sent to an analyzing unit 11. The analyzing unit 11 compares the detection signal with a pre-stored appropriate range signal to judge the polishing performance of the polishing liquid. The reaction unit 12, the detecting unit 10, and the analyzing unit 11 constitute a polishing liquid freshness judging unit. The analyzing unit 11 sends a polishing performance judgment signal of the reaction liquid to a polishing liquid control unit 20. The polishing liquid control unit 20 controls a polishing liquid supply pump 7 (see FIG. 4) on the basis of the polishing performance judgment signal to thereby control a flow rate of the polishing liquid (slurry) to be supplied onto a polishing pad 2.

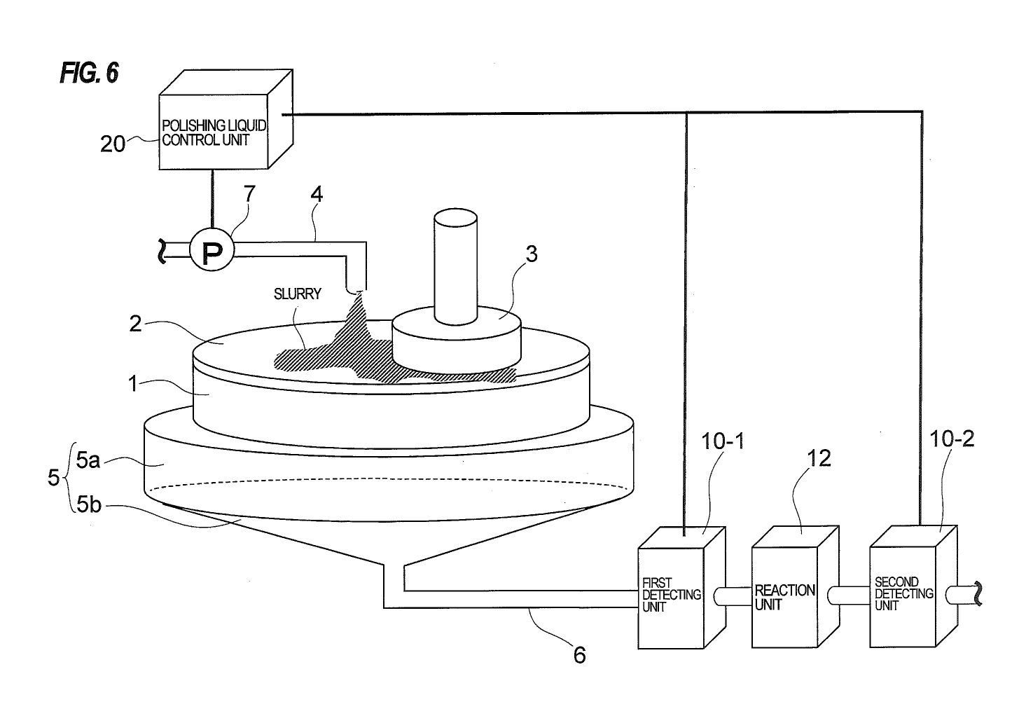

FIG. 6 is a schematic perspective view showing still another embodiment of a polishing apparatus which performs the method for judging polishing performance of the polishing liquid. In the embodiment shown in FIG. 6, a polishing waste liquid extracted (or collected) by a polishing waste liquid extraction mechanism 5 is delivered to a first detecting unit 10-1 through a waste liquid pipe 6. A predetermined component of the polishing waste liquid is detected in the first detecting unit 10-1, and then the polishing waste liquid is delivered to a reaction unit 12. The polishing waste liquid after the reaction in the reaction unit 12 is delivered to a second detecting unit 10-2. Other structure is the same as that of the polishing apparatus shown in FIG. 4.

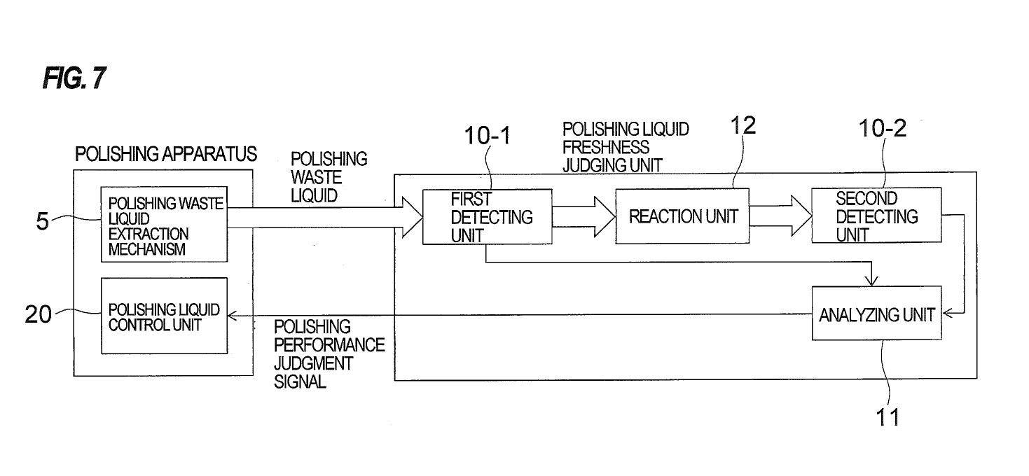

FIG. 7 is a block diagram showing an example of a control configuration in the polishing apparatus shown in FIG. 6. As shown in FIG. 7, the polishing waste liquid is delivered to the first detecting unit 10-1 from the polishing waste liquid extraction mechanism 5 of the polishing apparatus. A predetermined component of the polishing waste liquid is detected in the first detecting unit 10-1, and the detection signal is sent to an analyzing unit 11. The polishing waste liquid discharged from the first detecting unit 10-1 is delivered to the reaction unit 12, and the polishing waste liquid after the reaction in the reaction unit 12 is delivered to the second detecting unit 10-2. A predetermined component of the polishing waste liquid is detected in the second detecting unit 10-2, and the detection signal is sent to the analyzing unit 11. The analyzing unit 11 compares the detection signal obtained in the first detecting unit 10-1 and the detection signal obtained in the second detecting unit 10-2 to judge the polishing performance of the polishing liquid. The first detecting unit 10-1, the second detecting unit 10-2, the reaction unit 12, and the analyzing unit 11 constitute a polishing liquid freshness judging unit. The analyzing unit 11 sends a polishing performance judgment signal of the polishing liquid to a polishing liquid control unit 20. The polishing liquid control unit 20 controls a polishing liquid supply pump 7 (see FIG. 6) on the basis of the polishing performance judgment signal to thereby control a flow rate of the polishing liquid (slurry) to be supplied onto a polishing pad 2.

The detecting unit 10, the first detecting unit 10-1, and the second detecting unit 10-2 shown in FIGS. 2 through 7 use the above-described various detecting methods suitably to detect that the concentrations of the inhibitor and the accelerator fall within respective appropriate ranges and that the concentration ratio of the complexing agents having both actions falls within a certain range.

The reaction unit 12 shown in FIGS. 4 through 7 will be described below.

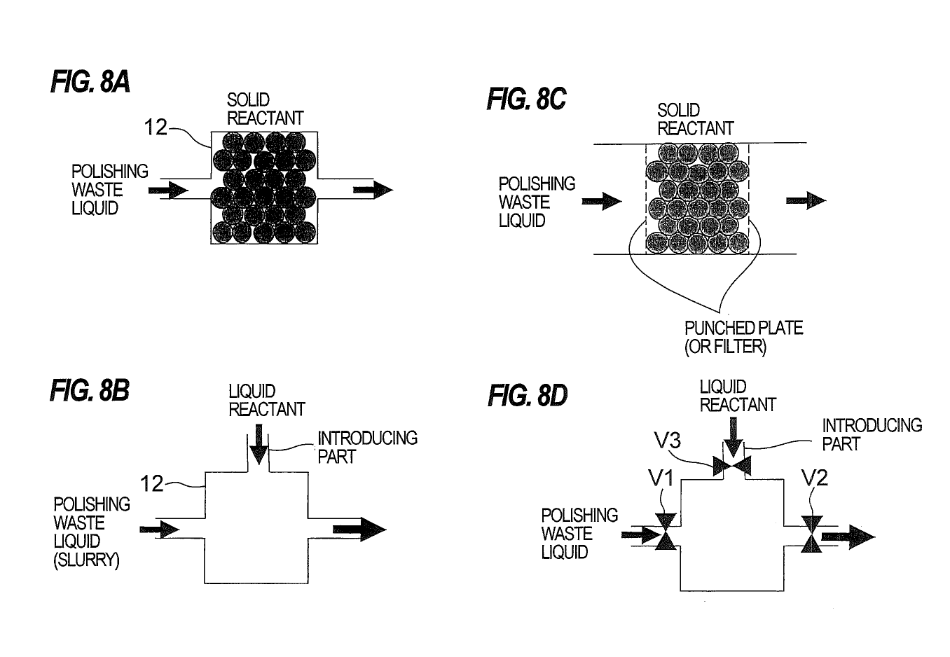

FIGS. 8A, 8B, 8C and 8D are schematic views each showing a configuration of the reaction unit.

The reaction unit 12 comprises a configuration, as shown in FIG. 8A, comprising a fluid passage which is filled with and holds a solid reactant, or a configuration, as shown in FIG. 8B, comprising a fluid passage in which a liquid reactant is added to be mixed with the slurry. The solid reactant is composed of a metal, an oxide, a compound containing a metal (salt, electrolyte, complex), or the like, and is in the shape of a particle, a sheet, a structure, a fluid passage wall, or the like. The liquid reactant is composed of a coloring agent, a fluorescence reagent, a coloring reagent, and the like. Further, the reaction unit 12 has a mechanism for holding the solid reactant, and such mechanism includes a fluid passage structure (FIG. 8A) with a portion having an enlarged diameter, a sealing structure (FIG. 8C) such as a punched plate and a filter, and the like. Furthermore, in order to replace the liquid reactant, to clean the reaction unit, or to regenerate the solid reactant, as shown in FIG. 8B, there may be provided an introducing part for a liquid reactant as a switching mechanism of the fluid passage, in addition to an inlet and an outlet for the slurry. Further, as shown in FIG. 8D, there may be provided valves V1, V2 and V3 at the inlet and the outlet for the slurry and the introducing part for the liquid reactant, respectively, in order to control processes of the reaction in the reaction unit, the cleaning of the reaction unit, and the regeneration of the solid reactant.

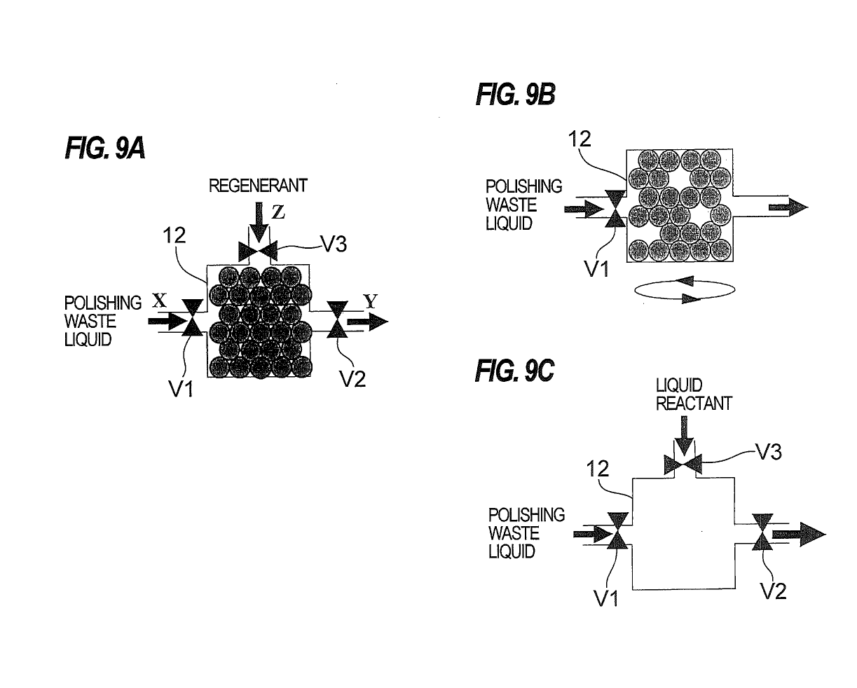

The reaction unit 12 may be equipped with a regeneration mechanism. FIGS. 9A, 9B and 9C are schematic views each showing a configuration of a reaction unit having a regeneration mechanism. As shown in FIG. 9A, there is a method in which regeneration is performed by adding a regenerant by means of valve switching. Specifically, at the time of reaction, the polishing liquid is flowed in a direction from X to Y with valves V1 and V2 open and with a valve V3 closed; and at the time of regeneration, the regenerant is flowed in a direction from Z to Y with the valve V1 closed and with the valves V2 and V3 open to thereby regenerate the solid reactant. The regenerant comprises a chemical solution, a chemical solution containing abrasive particles, an acid, an alkali, or the like. Further, as shown in FIG. 9B, there is a method for regenerating the solid reactant by agitation or forcible vibration. Specifically, a rotating member is inserted into the reaction unit 12, or a load by an external driving force is applied to the reaction unit itself. Further, the solid reactant is irradiated with ultrasonic wave or light, or the solid reactant is heated. Moreover, as shown in FIG. 9C, in the case of the liquid reactant, cleaning can be performed by switching of valves V1, V2 and V3. Specifically, at the time of cleaning, only the liquid reactant is flowed into the reaction unit 12 with the valve V1 closed and with the valves V2 and V3 open.

In order to detect the manner in which the component concentration in the CMP slurry varies with the progress of polishing, in substantially real time, the slurry liquid needs to be introduced into the detector through the shortest possible fluid passage. Thus, the fluid passage connected to the reaction unit needs to be as short as possible, and the volumes of the reaction unit, the separating unit, and the detecting unit need to be small.

On the other hand, it is possible to reduce the amount of slurry required for detection by increasing detection sensitivity of the detecting unit, thus shortening detection time. In the case of the solid reactant, a method in which the surface area of the solid reactant is increased is effective to increase the detection sensitivity. Specifically, there are a method for increasing the amount of the solid reactant and a method for reducing particle diameters of the solid reactant. Further, since heating increases the detection sensitivity, a method in which the time and the passage length from the collection of the polishing waste liquid to the measurement thereof are shortened to thereby utilize the temperature of the slurry which has been heated by polishing heat during polishing is efficient.

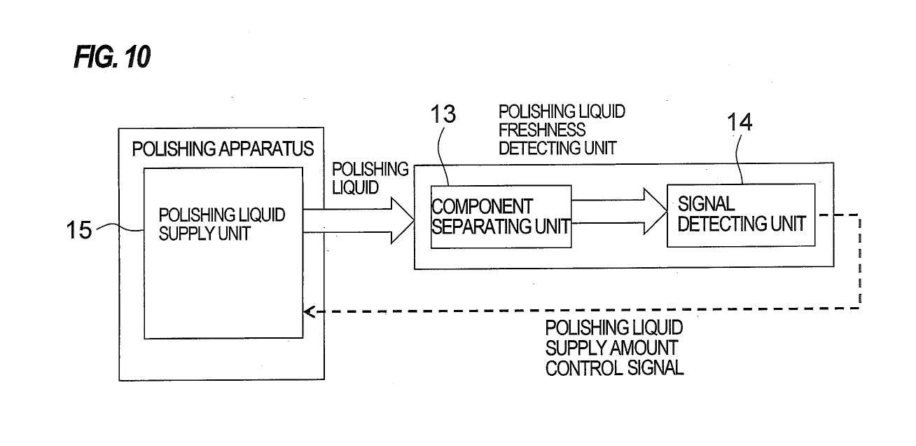

FIG. 10 is a block diagram showing an embodiment in which a component separating means is provided at an upstream side of the measurement unit of the component concentration of the polishing liquid or the polishing waste liquid to estimate the polishing performance of the polishing liquid.

As shown in FIG. 10, the polishing liquid (or polishing waste liquid) is delivered to a component separating unit 13, where components of the accelerator and the inhibitor are separated. The component separating unit 13 comprises a chromatography column, and the chromatography column comprises gel which adsorbs the complexing agents distinctively. A signal detecting unit 14 detects respective component concentrations of the liquid after the separation by the component separating unit 13. The signal detecting unit 14 comprises an ultraviolet light absorption detector or a refractive index detector. The signal detecting unit 14 may employ an electrochemical method. The component separating unit 13 and the signal detecting unit 14 constitute a polishing liquid freshness detecting unit. The signal detecting unit 14 sends a polishing liquid supply amount control signal to a polishing liquid supply unit 15.

Although the preferred embodiments of the present invention have been described above, it should be understood that the present invention is not limited to the above embodiments, but various changes and modifications may be made to the embodiments without departing from the scope of the appended claims.

What is claimed is:

1. A method for judging polishing performance of a polishing liquid containing an accelerator for promoting dissolution of an object to be polished and an inhibitor for inhibiting dissolution of the object to be polished, the method comprising:
analyzing a polishing waste liquid by spectroscopy;
selecting a plurality of wavelengths from wavelengths which can distinguish the accelerator, the inhibitor, and a complex compound of the accelerator and a metal to be polished, respectively; and
measuring absorbance at the selected plurality of wavelengths to thereby judge the polishing performance of the polishing liquid.

2. The method according to claim 1, wherein the wavelengths at which the absorbance is measured comprise a plurality of wavelengths selected from a range of 200 to 900 nm.

3. The method according to claim 1, wherein at least one wavelength is selected from a range of 200 to 255 nm or a range of 450 to 900 nm, and at least one more wavelength is selected from a range of 255 to 310 nm.

4. The method according to claim 1, wherein at least one wavelength is selected from a range of 255 to 310 nm, and at least one more wavelength is selected from wavelengths of ions of the metal to be polished.

5. The method according to claim 4, further comprising:
measuring electrochemical properties or chromaticity of ions of the metal to be polished, instead of selecting the at least one more wavelength from the wavelengths of the ions of the metal to be polished;
wherein the polishing performance of the polishing liquid is judged by the absorbance at the wavelength selected from the range of 255 to 310 nm of the polishing waste liquid, and one of the measured electrochemical properties and the measured chromaticity of the ions of the metal to be polished.

6. A method for judging polishing performance of a polishing liquid comprising:
measuring a component concentration of a polishing waste liquid to obtain a signal value based on the measured value; and
processing the obtained signal value and a pre-obtained signal value to thereby judge the polishing performance of the polishing liquid.

7. The method according to claim 6, wherein a method for measuring the component concentration comprises an electrochemical method.

8. The method according to claim 6, wherein a method for measuring the component concentration comprises spectroscopy.

9. The method according to claim 8, wherein a wavelength to be measured comprises a wavelength selected from a range of 200 to 900 nm.

10. The method according to claim 8, wherein wavelengths to be measured comprise a plurality of wavelengths selected from a range of 200 to 900 nm.

11. The method according to claim 6, wherein components of the polishing waste liquid is separated by a component separating device, and each component concentration is measured after the separation.

12. The method according to claim 11, wherein the separating device of the polishing waste liquid comprises chromatography.

13. The method according to claim 11, wherein the component concentration is measured by detecting a physical concentration change.

14. The method according to claim 11, wherein the component concentration is measured by an optical refractive index method or a light scattering method.

15. A method for judging polishing performance of a polishing liquid comprising:
causing a polishing waste liquid to pass through a reaction unit having a reactant which reacts with the polishing waste liquid, thereby causing the polishing waste liquid to react with the reactant;
measuring a component concentration of the polishing waste liquid after the reaction in the reaction unit to obtain a signal value based on the measured value; and
processing the obtained signal value and a pre-obtained signal value to thereby judge the polishing performance of the polishing liquid.

16. An apparatus for judging polishing performance of a polishing liquid comprising:
a detecting unit configured to detect a component of a polishing waste liquid extracted from a polishing apparatus to obtain a detection signal; and
an analyzing unit configured to analyze the detection signal sent from the detecting unit to thereby judge the polishing performance of the polishing liquid.

17. The apparatus according to claim 16, wherein the component of the polishing waste liquid is detected by an electrochemical method.

18. The apparatus according to claim 16, wherein the component of the polishing waste liquid is detected by spectroscopy.

19. The apparatus according to claim 18, wherein a wavelength to be measured comprises a wavelength selected from a range of 200 to 900 nm.

20. The apparatus according to claim 18, wherein wavelengths to be measured comprise a plurality of wavelengths selected from a range of 200 to 900 nm.

21. The apparatus according to claim 16, wherein components of the polishing waste liquid are separated by a component separating device, and each component of the polishing waste liquid is detected after the separation.

22. The apparatus according to claim 21, wherein the separating device of the polishing waste liquid comprises chromatography.

23. The apparatus according to claim 16, wherein the component of the polishing waste liquid is detected by detecting a physical concentration change, or by an optical refractive index method or a light scattering method.

24. A polishing apparatus comprising:
a polishing table configured to support a polishing pad;
a holding device configured to hold an object to be polished;
a polishing liquid supply device configured to supply a polishing liquid onto the polishing pad;
a polishing waste liquid extraction mechanism configured to extract a polishing waste liquid discharged from the polishing pad;
an apparatus for judging polishing performance according to claim 16; and
a polishing liquid control unit connected to the apparatus for judging the polishing performance;
wherein the apparatus for judging the polishing performance detects a component of the polishing waste liquid to obtain a detection signal, analyzes the detection signal to obtain a polishing performance judgment signal, and sends the polishing performance judgment signal to the polishing liquid control unit; and
the polishing liquid control unit controls a flow rate of the polishing liquid to be supplied onto the polishing pad.
